(19) United States
(12) Patent Application Publication
(10) Pub. No.: US 2012/0062182 A1
(43) Pub. Date: Mar. 15, 2012

(54) Intelligent Power Supply

(75) Inventors: Donald Rimdzius, Addison, IL (US); James W. McGinley, Barrington, IL (US); Dominic James Hogan, Appleton, WI (US)

(73) Assignee: Voltstar Technologies, Inc., Schaumburg, IL (US)

(21) Appl. No.: 12/882,165

(22) Filed: Sep. 14, 2010

(51) Int. Cl. H02J 7/04; H02J 7/00

(52) U.S. Cl. 320/155; 320/137; 320/162

(57) ABSTRACT

Described herein is technology for, among other things, a power supply for connection with and supplying power to an electronic device, and/or for charging a battery thereof. The power supply includes an input for receiving input power, an output for providing DC output power to the electronic device, and circuitry operable to determine an attribute of the battery and adjusting a charging characteristic of the power supply based on the attribute.

### BACKGROUND

1. Field

Embodiments of the present invention are generally directed to chargers for portable electronic devices having rechargeable batteries.

2. Background

In today's consumer marketplace, there are literally thousands of portable electronic devices available to consumers, the vast majority of which require an external charger for periodically recharging an internal battery thereof. Early portable electronic devices and their chargers typically utilized non-standard charging voltages and communicated via non-standard, proprietary connectors. Thus, in many households, a separate charger was typically required for each portable electronic device.

There have been recent efforts toward standardizing chargers for some of the smaller portable electronic devices, such as cellular telephones and portable media players. For example, many newer portable electronic devices utilize a micro-USB interface for purposes of charging. However, to the extent chargers have been developed that are adapted to provide charging power via a USB interface, such chargers are “dumb” in the sense that they are unable to adapt to the different charging needs of different devices and/or batteries.

Additionally, there are commonly known methods of measuring current flow in electronic circuitry, such as chargers for portable electronic devices. The most common method, which is shown in FIG. 1, is to place a small series resistance in the path of the current flow. When current I flows through the small series resistance R_{SENSE,} a voltage drop V_{SENSE} is generated across the resistor that is proportional to the current flow.

This common method of current measurement is limited by several problems. The series resistance consumes energy, making it wasteful, especially when larger currents flow through the resistor. The series resistance also generates heat, which must be dissipated. The series resistor further imposes a voltage drop on the supplied power that varies with load, thereby negatively affecting the voltage regulation performance of the supplied power. On the other hand, if the series resistance is kept small to reduce energy consumption and voltage drop, it is difficult to accurately measure very low current values since the voltage drop across the series resistor may have a very small amplitude, making it susceptible to, and affected by, electrical noise.

Circuitry attempting to accurately measure the very small voltages across a series resistance adds significant cost and complexity to the circuit. Moreover, if the current measurement is to be used by a microprocessor for intelligent purposes, the analog voltage generated by the series resistance must be converted into a digital signal. This analog to digital signal conversion process adds further cost and complexity to the circuit.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Described herein is technology for, among other things, a power supply for connection with and supplying power to an electronic device, and/or for charging a battery thereof. The power supply includes an input for receiving input power, an output for providing DC output power to the electronic device, and circuitry operable to determine an attribute of the battery and adjusting a charging characteristic of the power supply based on the attribute.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a schematic of a prior art current sense circuit employing series resistance;

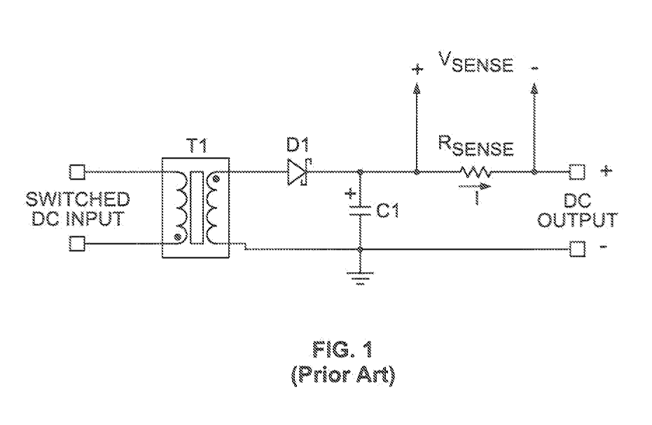

FIG. 2 is a block diagram of a first power supply circuit, in accordance with various embodiments of the present invention;

FIG. 3 is a schematic of the first power supply circuit, in accordance with various embodiments of the present invention;

FIG. 4 is a block diagram of a second power supply circuit, in accordance with various embodiments of the present invention;

FIG. 5 is a schematic of the second power supply circuit, in accordance with various embodiments of the present invention;

FIG. 6 is a schematic of a third power supply circuit, in accordance with various embodiments of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Switched mode power conversion is employed due to its high efficiency and smaller physical size and weight. This power conversion technology alternately switches power on and off in a controlled pattern to a conversion element such as a transformer or inductor to provide a different voltage level at the output of the convertor than at the input. The on-off switching pattern may vary the duty cycle, pulse width, pulse frequency, or various combinations thereof. The energy transferred from the input to the output of the power conversion device is closely correlated to the switching pattern. Thus, by monitoring and measuring the switching pattern, the magnitude of power or current being output from the switched mode power converter can be accurately measured without the need for a series resistance. The sensed power and/or current draw can then be used to adjust a charging characteristic of a power supply, as well as in the decision process to shut off power to the power device when the attached electronic device battery is charged, the attachment cable is disconnected, or the electronic device is powered down.

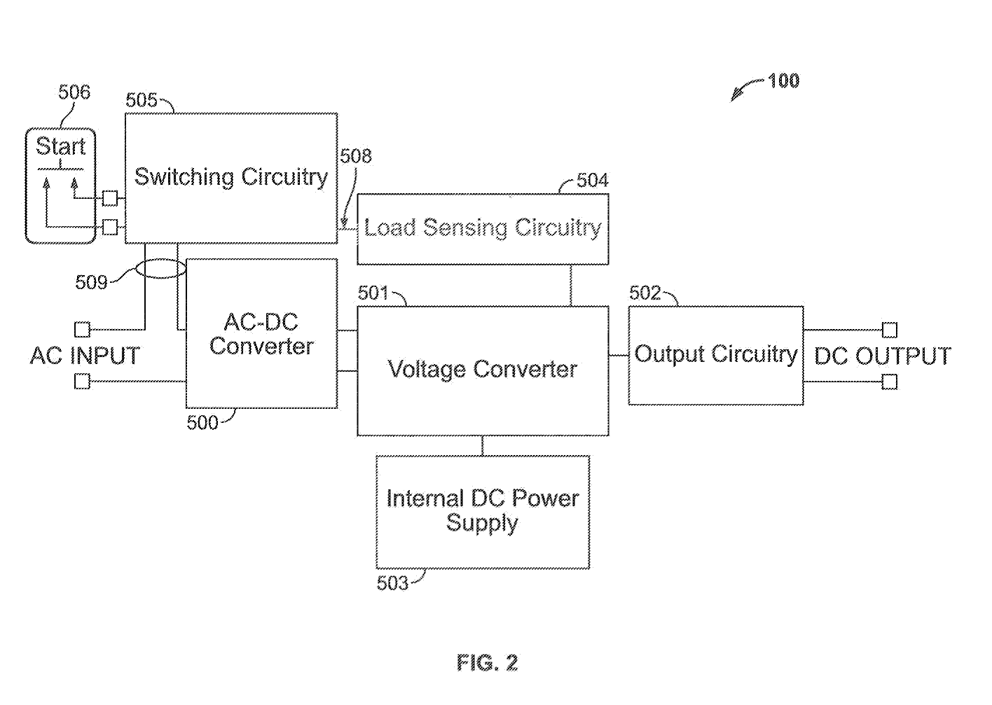

FIG. 2 illustrates a block diagram of a power supply circuit 100, in accordance with various embodiments of the present invention. Power supply circuit 100 is adapted for connection with and supplying power to an electronic device, e.g. for charging a battery thereof. Circuit 100 includes an AC-DC converter 500, which is operable to receive AC voltage from an AC power source, such as a wall outlet, and convert it to a DC voltage. Although the power supply circuit may be described and depicted herein as having an AC-DC converter 500, embodiments of the present invention are not limited as such. For example, other embodiments of power supply circuits may alternatively include a DC-DC converter for receiving a first DC voltage from an DC power source, such as a vehicle outlet, and converting it to a second DC voltage that is usable by the electronic device.

Circuit 100 may also include a voltage converter 501 coupled with the AC-DC converter 500. The voltage converter 501 is operable to convert the DC voltage received from the AC-DC converter 500 into a voltage usable by the electronic device. For example, the voltage received from the AC-DC converter 500 may be a relatively high DC voltage, which the voltage converter 501 may then step down to a level appropriate for use by small, portable electronic devices (e.g., 5 V). In one embodiment, the voltage converter 501 may include a transformer, and the voltage converter 501 may utilize switched mode power conversion, whereby it switches the high voltage DC received from the AC-DC converter 500 on and off in a controlled manner into an input winding of the transformer. The power supply circuit 100 may also include output circuitry 502 coupled with the voltage converter 501 and operable to receive a pulsed, low voltage DC signal from the voltage converter 501 and filter it into a more steady DC voltage. The output circuitry 502 then makes this DC voltage available for powering and/or charging external electronic devices.

The power supply circuit 100 may also include load sensing circuitry 504 that determines the current or power being supplied to the external load (i.e. the electronic device and/or its battery). In one embodiment, the load sensing circuitry 504 determines the current or power being supplied by counting the on/off cycles or pulses that voltage converter 501 sends to a transformer thereof; however, it will be appreciated that other conventional methods of measuring power and/or current may be used. The load sensing circuitry 504 may condition the aforementioned pulses and/or count them over a time period and then equate the result with the magnitude of current or power being supplied. The load sensing circuitry 504 may include one or more controllers or microprocessors, which may utilize various algorithms to assess multiple pulse count measurements and determine the external device's charging needs as well as when to disconnect AC power from the circuit. In one embodiment, when the load sensing circuitry 504 determines that the AC power should be disconnected, it sends a signal via connection 508 to switching circuitry 505, which is operable to turn the power supply circuit 100 on or off responsive to one or more signals, including the signal received from the load sensing circuitry 504 via connection 508. In the present example, the switching circuitry 505 turns the power supply circuit 100 off in response to receiving a power off signal from load sensing circuitry 504.

In various embodiments, the switching circuitry 505 turns the power supply circuitry 100 on and off by connecting and disconnecting AC power from the power supply circuitry 100. In embodiments where all AC power is disconnected from the power supply circuitry 100, the power supply circuitry 100 may utilize external means of powering up. One example of an external means of powering up is a user-operated momentary switch 506. In one embodiment, closing switch 506 creates a closed state across conductors 509, which results in the connection of both conductors of the AC input to the AC-DC converter 500, which powers up the remainder of the power supply circuit 100. Switching circuitry 505 may detect this power up condition and change its internal state to correspond to an “on” state of the power supply circuit 100. This maintains AC power flow to the power supply circuit 100 once the switch 506 is opened. Another example of an external means of powering up is temporarily drawing power from the electronic device itself, as discussed in greater detail below.

The power supply circuit 100 may also include an internal DC power supply, which may provide power any other circuitry of the power supply circuit 100 that requires DC power, such as load sensing circuitry 504 and/or switching circuitry 505.

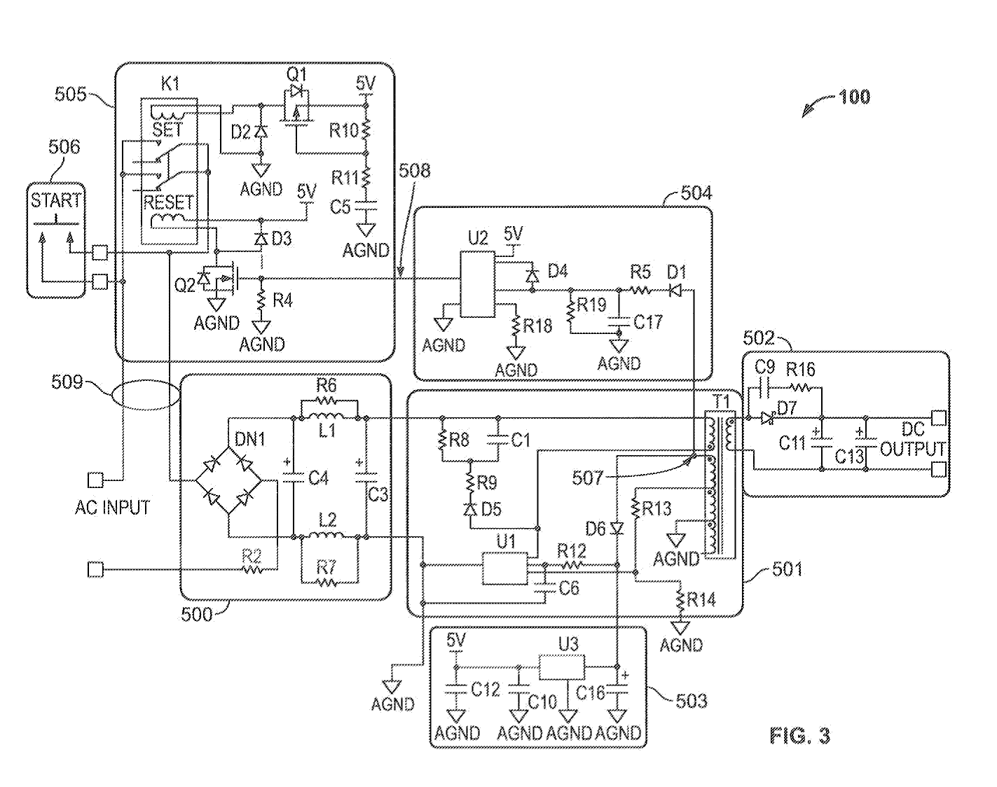

It should be appreciated that circuit 100 and its various components may be implemented in a number of ways. For example, FIG. 3 illustrates a schematic of one implementation of power supply circuit 100 of FIG. 2, in accordance with various embodiments of the present invention, including exemplary embodiments of AC-DC converter 500, voltage converter 501, output circuitry 502, internal DC power supply 503, load sensing circuitry 504 and switching circuitry 505.

As referenced above, the voltage converter 501 may include a transformer T1. In the illustrated embodiment, the voltage converter includes a switched mode power supply controller U1, which is operable to control the switching of the high-voltage DC into the transformer T1. In one embodiment, the controller U1 may vary the switching method based on the power demands of the electronic device. For example, when the power demand of the electronic device is low, the controller U1 may generate fixed-width pulses, and then increase their frequency as the power demand increases. However, once the power demand reaches a certain level, the controller U1 may instead vary the duty cycle of the pulses.

The load sensing circuitry 504 may couple with the voltage converter 501 at node 507. However, it will be appreciated that other connection points may also be used. In the illustrated embodiment, node 507 is the connection to a primary winding of transformer T1, and is where pulses are monitored by the load sensing circuitry 504. The load sensing circuitry 504 conditions the pulses and then sends them to its microprocessor U2. Microprocessor U2 then analyzes the pulses over a time period and correlates the result with the magnitude of current or power being supplied to the electronic device and/or its battery. Microprocessor U2 thus uses one or more algorithms to assess multiple pulse count measurements and determine the external device's charging needs, as well as when to turn the power supply circuit 100 off. In one embodiment, when the microprocessor U2 determines that the power supply circuit 100 should be turned off, it sends a signal via connection 508 to switching circuitry 505. Switching circuitry 505 accordingly causes the power supply circuit 100 to turn off.

In the illustrated embodiment, switching circuitry 505 includes a bi-stable relay K1. This type of relay has the advantage that it consumes power only while it is being switched between its open and closed contact states. When power is removed from the bi-stable relay K1, it retains its last contact position state. When bi-stable relay K1 in the switching circuitry 505 receives the signal from the microprocessor U2 to disconnect AC power, it changes the relay contacts to an open state. The open state is reflected at conductors 509 and results in the disconnection of a conductor of the AC Input to the AC-DC converter 500, thereby preventing any AC power from flowing to the power supply circuitry.

As discussed above with respect to FIG. 2, in order to turn the power supply circuit 100 back on, the power supply circuitry 100 may utilize external means, such as momentary switch 506, to power up. In the illustrated embodiment, closing switch 506 creates a closed state across conductors 509, which results in the connection of both conductors of the AC input to the AC-DC converter 500, which in turn powers up the remainder of the power supply circuit 100. Switching circuitry 505 may then detect the power up condition and send a momentary signal to bi-stable relay K1, charging the state of the relay contacts from open to closed.

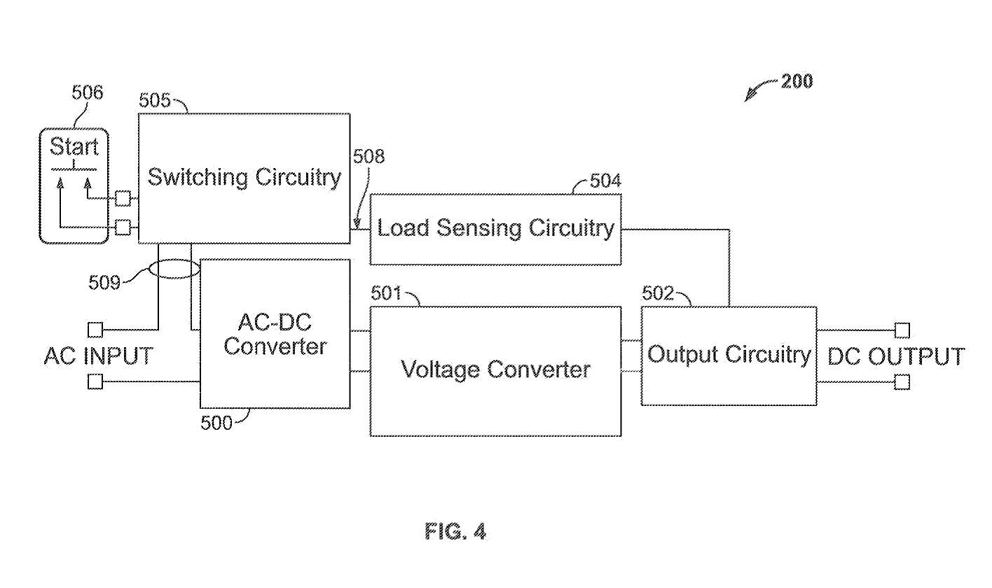

FIG. 4 illustrates a block diagram for an alternative power supply circuit 200, in accordance with various embodiments of the present invention. The power supply circuit 200 of FIG. 4 is similar to the power supply circuit 100 of FIGS. 2 and 3 in some ways, and different in others.

As mentioned above, the load sensing circuitry 504 may monitor the power and/or current being delivered to the external electronic device at various different locations within the power supply circuitry. In the illustrated embodiment, the load sensing circuitry 504 monitors the power and/or current being delivered to the external electronic device from within the output circuitry 502, instead of within the voltage converter 501, as is shown in FIGS. 2 and 3.

The power supply circuit 200 embodiment of FIG. 4 also does not have its own internal DC power supply separate from the output circuitry 502. Rather, the output circuitry 502 supplies the DC power for any other internal circuitry that utilizes DC power, such as the load sensing circuitry 504 and the switching circuitry 505.

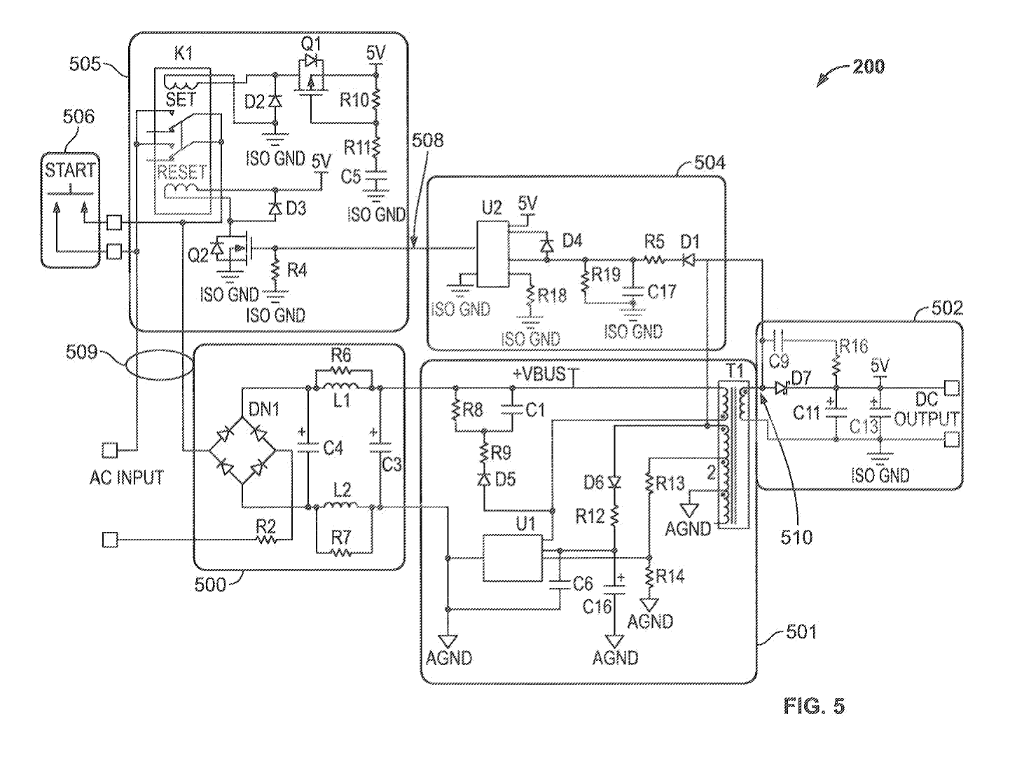

FIG. 5 illustrates a schematic of one possible implementation of power supply circuit 200, in accordance with various embodiments of the present invention. In the illustrated embodiment, the load sensing circuit 504 monitors pulses from a secondary winding of Transformer T1, at node 510.

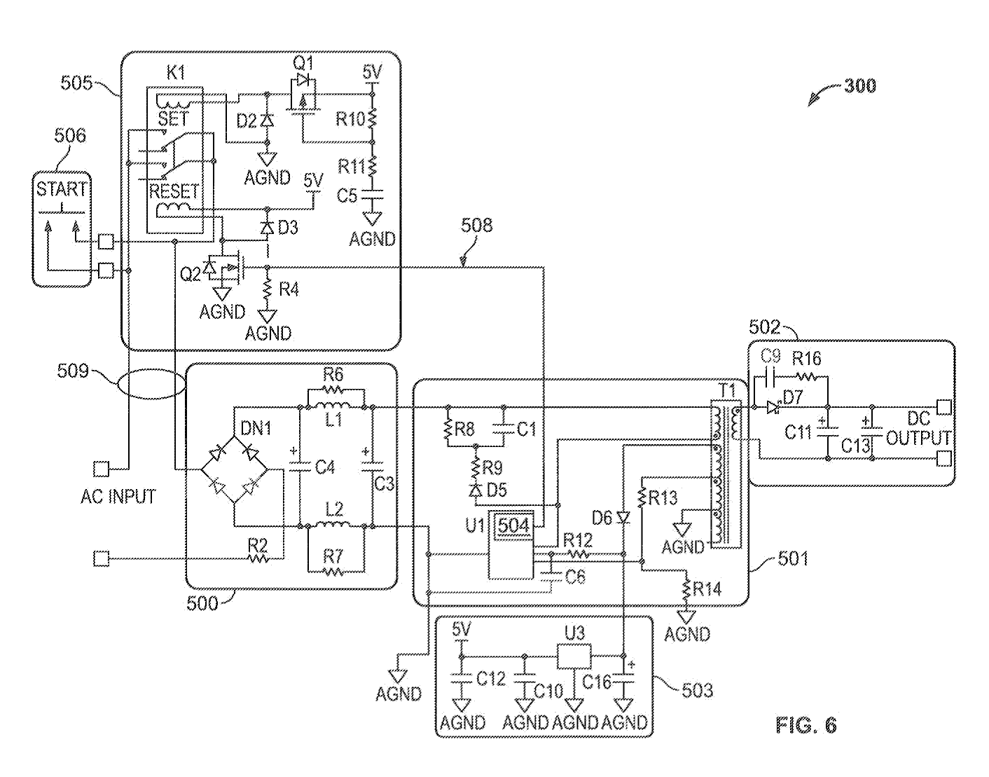

In still other embodiments, the load sensing circuitry 504, or an equivalent thereof, may be integrated within an intelligent integrated circuit (IC). FIG. 6 is a schematic of such an embodiment. As shown, the load sensing circuitry 504 may be integrated within IC U1. Load sensing circuitry 504 may include logic circuits, and/or microprocessors.

In various embodiments, the load sensing circuitry 504 may monitor the load of the electronic device at various points in the charging process towards identifying certain attributes of the electronic device and/or its battery. Such attributes may include, but are not limited to, the battery size and the current state of charge of the battery. The power supply circuit may use these attributes to adjust one or more of its charging characteristics, including but not limited to, altering the load level required to shut down the power supply circuit or altering other conditions for power shutdown, including charging time, charging power profile over time, and total energy delivered to the electronic device and/or battery.

In one embodiment, the load sensing circuitry 504 may sense signal pulses that may be generated by IC U1, or a similar functioning circuit, which switches power to the transformer T1 on and off in an alternating fashion. These signal pulses can be sensed on the primary windings of the transformer T1 (e.g. node 507), on the secondary windings of the transformer T1 (e.g. node 510), from IC U1 directly, or from other related circuits.

In one embodiment, load sensing circuitry 504 determines how slow or fast these signal pulses are repeated by counting the pulses over a time period to determine a pulse count. The total count of pulses over a time period (pulse count) will be related to the magnitude of total load of the electric device. For example, a larger pulse count may represent a higher power draw by the electronic device, and a lower pulse count may represent a lower power draw by the electronic device. Load sensing circuitry 504 may monitor pulse counts over individual, successive or intermittently sampled time periods to track the load and/or changes in the load of the electronic device. Load sensing circuitry 504 can compare this pulse count value against one or several programmed or calculated pulse count values and adjust a charging characteristic of the power supply circuit based on the result of this comparison.

In another embodiment, the load sensing circuitry 504 measures the duty-cycle of the power conversion switching pattern by sampling the signal pulses to thereby determine an on/off ratio, an on/off time period, or a combination thereof, which are related to the load of the electronic device.

Still further, the load sensing circuitry 504 may vary the method by which it analyzes the pulses (e.g. counting vs. measuring duty cycle), for example, based upon the method by which the controller U1 is switching the high voltage DC to the transformer T1.

In yet another embodiment, the power conversion switching output may be processed through a resistive/capacitive time constant circuit which outputs a voltage or signal related to the load of the electronic device.

The load sensing circuitry 504 may monitor and store the current flow that occurs after power up. In one embodiment, the load sensing circuitry 504 notes the peak current flow that occurs after power up. Since the charging current of almost all Li-Ion battery powered electronic devices is controlled and limited by circuits in the electronic device or battery, and the maximum charging current in electronic devices is typically a fixed percentage of the battery capacity or size, the size of the battery can be determined based on the amount of power and/or current drawn. The maximum current flow typically occurs within the first several minutes (e.g. 20 minutes) of charging, and usually within the first several seconds (e.g. 10 seconds). For a 1 amp, 5 volt charger, battery size of the electronic device can be divided into two categories—large and small—with good results in shutoff performance. In one embodiment, a large battery is a battery that consumes more than a predetermined level of current (e.g. between about 200 mA and about 1 A on startup), and a small battery is a battery that consumes less than the predetermined level on startup. In one embodiment, when a large battery is detected, a shut-off current set point for the power supply circuit is set to a first value (e.g. 60-120 mA), and when a small battery is detected, the shutoff current set point for the power supply circuit is set to a second, lower value (e.g. 10-50 mA). When the current drawn by the electronic device falls below the shutoff current set point, the power supply circuit may be shut off. Although the foregoing discussion refers to two different sizes of batteries (i.e. large and small), it should be a appreciated that several battery size categories can be defined.

If the power supply circuit powers an electronic device with a fully charged battery, the peak charging current drawn by the electronic device may be much lower than if the battery were partially discharged. In such a case, the power supply circuit may not be able to use the peak current flow to judge the battery size. However, fully charged electronic devices will typically reduce their charging current at a much more rapid pace than electronic devices requiring a substantial charge. The peak charging current may be compared against the charging current after a period of time to determine a rate of drop in charging current over time. If this rate of drop exceeds a set or calculated value, the electronic device is assumed to be charged and the power supply circuitry is shut off.

On the other hand, if an electronic device with a severely depleted battery is charged, the charging current is limited by the electronic device to a very low current for an initial period of time, in order to condition the battery before allowing a full charge current to flow. The power supply circuit accommodates this preconditioning period by initially setting the shutoff current set point to a low value (e.g. 1-15 mA) for an initial period of time (e.g. the first 10-20 minutes). This prevents premature shutoff when an electronic device is drawing a low preconditioning current.

In various embodiments, the power supply circuit may be connected to the electronic device by a multi-conductor cable. This cable may have a pair of conductors that transfer the output power of the power supply circuit to the electronic device. Power from a power source in the electronic device can be sent to the power supply circuit on at least one additional conductor in this cable. This power flow from the electronic device to the power supply circuit serves as an alternative mechanism to the switch 506 for enabling the power supply circuit to reestablish its power connection to the AC mains to turn on the power supply circuit. The absence of power flow from the electronic device to the power supply circuit may likewise serve as a signal to the power supply circuit to disconnect AC power to the power supply circuit, which shuts off the power supply circuit.

In one embodiment, the multi-conductor cable connection to the electronic device may be to a USB port. The aforementioned additional signal conductor may be connected to the D+, D−, or Vbus as defined by the USB standard.

When the multi-conductor cable is attached to the electronic device USB port, the electronic device may supply power to the charger via the Vbus connected conductor based on the USB on-the-go connection protocol whereby the charger initially appears to the electronic device as a peripheral based on the connection of the USB defined ID signal tied to ground. Under this condition, the electronic device supplies power to the power supply circuit via the Vbus and ground conductors of the cable. The power supply circuit can then use this power from the electronic device to engage an electronic switch or mechanical relay to reconnect AC mains power to the AC-DC converter 500. Once the power supply circuit powers up from the AC mains, it may signal the electronic device that it is a power device by removing, via a relay or electronic switch, the ID signal ground connection and shorting D+ and D−. After a delay, the power supply circuit then sends power to the electronic device via Vbus and ground.

Alternatively, when the multi-conductor cable is attached to the electronic device USB port, the electronic device may supply a small amount of power to the power supply circuit via the D+ and or D− conductors, when the electronic device employs the USB Session Request and USB Attach Detection Protocols, whereby the power supply circuit initially appears to the electronic device as a peripheral and the electronic device supplies power to the charger via the Vbus and ground conductors of the cable. Under this condition, the electronic device supplies power to the power supply circuit via the D+ and/or D− conductors. The power supply circuit uses this power from the electronic device to engage an electronic switch or mechanical relay to reconnect AC mains power to the AC-DC converter 500. Once the power supply circuit powers up from the AC mains, it may signal the electronic device, via the D+ and D− conductors, that it is a power supply circuit and then send power to the electronic device via Vbus.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A power supply for connection with and supplying power to an electronic device, and for charging a battery thereof, the power supply comprising:
an input for receiving input power;
an output for providing DC output power to the electronic device; and
circuitry operable to determine an attribute of the battery and adjust a charging characteristic of the power supply based on the attribute.

2. The power supply as recited in claim 1, wherein the attribute comprises a size of the battery.

3. The power supply as recited in claim 2, wherein the circuitry is operable to adjust a charging characteristic of the power supply based on the attribute by adjusting a set point at which the power supply is automatically shut off, based on the size of the battery.

4. The power supply as recited in claim 3, wherein the circuitry includes load sensing circuitry that is operable to monitor load drawn from the power supply by the electronic device, wherein the circuitry is further operable to set the set point based on the load drawn from the power supply by the electronic device.

5. The power supply as recited in claim 4, wherein the load sensing circuitry comprises current sense circuitry that is operable to measure a current being provided to the electronic device.

6. The power supply as recited in claim 4, wherein the circuitry is operable to set a load threshold value of the set point to a first value when the load drawn is below a predetermined level and set the load threshold value of the set point to a second value when the load drawn is above the predetermined level.

7. The power supply as recited in claim 6, wherein the load threshold value corresponding to the first value is lower than the load threshold value corresponding to the second value.

8. The power supply as recited in claim 4 further comprising:
switching circuitry coupled with the load sensing circuitry and operable to automatically shut off the power supply based on the set point.

9. The power supply as recited in claim 8, wherein the switching circuitry is operable to automatically shut off the power supply when the load drawn falls below a load threshold value of the set point.

10. The power supply as recited in claim 1, wherein the circuitry is operable to adjust a maximum charging time of the power supply.

11. The power supply as recited in claim 1, wherein the circuitry is operable to adjust a maximum total amount of energy delivered to the battery.

12. In a power supply, a method for charging a battery of an electronic device coupled to the power supply, the method comprising:
providing DC output power to the electronic device for charging the battery;
determining an attribute of the battery; and
adjusting a charging characteristic of the power supply based on the attribute.

13. The method as recited in claim 12, wherein the attribute comprises a size of the battery.

14. The method as recited in claim 13, wherein adjusting a charging characteristic of the power supply based on the attribute comprises adjusting a set point at which the power supply is automatically shut off, based on the size of the battery.

15. The method as recited in claim 14, wherein determining the set point at which to automatically shut off the power supply based on the size of the battery comprises:
monitoring a load drawn from the power supply by the electronic device;
setting the set point based on the load drawn from the power supply by the electronic device.

16. The method as recited in claim 15, wherein monitoring the load drawn from the power supply by the electronic device comprises measuring a current being provided to the electronic device.

17. The method as recited in claim 15, wherein setting the set point based on the load drawn from the power supply by the electronic device comprises:
setting a load threshold value of the set point to a first value when the load drawn is below a predetermined level; and
setting the power threshold value of the set point to a second value when the load drawn is above the predetermined level.

18. The method as recited in claim 17, wherein the load threshold value corresponding to the first value is lower than the load threshold value corresponding to the second value.

19. The method as recited in claim 15 further comprising:
automatically shutting off the power supply based on the set point.

20. The method as recited in claim 19, wherein automatically shutting off the power supply based on the set point comprises automatically shutting off the power supply when the load falls below a load threshold value of the set point.

21. The method as recited in claim 12, wherein adjusting the charging characteristic of the power supply based on the attribute comprises adjusting a maximum charging time of the power supply.

22. The method as recited in claim 12, wherein adjusting the charging characteristic of the power supply based on the attribute comprises adjusting a maximum total amount of energy delivered to the battery.

23. A power supply for connection with and supplying power to an electronic device, and for charging a battery thereof, the power supply comprising:
an input for receiving input power;
an output for providing DC output power to the electronic device; and
circuitry operable to monitor a load drawn from the power supply by the electronic device and determine a size of the battery based thereon, to set a set point at which the power supply is automatically shut off to a first value when the battery is a first size, and to set the set point to a second value when the battery is a second size.
